(19) United States
(12) Patent Application Publication
(10) Pub. No.: US 2024/0329287 A1
(43) Pub. Date: Oct. 3, 2024

(54) OPTICAL FILTER

(71) Applicant: SEIKO EPSON CORPORATION, TOKYO (JP)

(72) Inventor: Kikuya MORITA, SHIOJIRI-SHI (JP)

(21) Appl. No.: 18/610,315

(22) Filed: Mar. 20, 2024

(30) Foreign Application Priority Data
Mar. 28, 2023 (JP) 2023-051081

(51) Int. Cl. G02B 5/26

(52) U.S. Cl. CPC G02B 5/26

(57) ABSTRACT

An optical filter includes a reflection film and a reflection film placed to face the reflection film via a gap. As seen from a direction in which the reflection films face, a range in which the reflection films overlap forms a light transmission region, and a dimension of the gap in a center portion of the light transmission region is smaller than a dimension of the gap in an outer peripheral portion outside of the center portion within the light transmission region.

The present application is based on, and claims priority from JP Application Serial Number 2023-051081, filed Mar. 28, 2023, the disclosure of which is hereby incorporated by reference herein in its entirety.

### BACKGROUND

### 1. Technical Field

The present disclosure relates to an optical filter.

### 2. Related Art

In related art, a spectroscopic camera spectroscopically separating a light from an object to be measured into a plurality of wavelengths and imaging is known, and the spectroscopic camera includes an optical filter that can spectroscopically separate a light having an selected wavelength (for example, see JP-A-2021-21067).

The optical filter disclosed in JP-A-2021-21067 includes a pair of reflection films placed to face each other via a gap. In the optical filter, multiple reflection of light is caused between the pair of reflection films and transmitted lights having a predetermined wavelength interfere to strengthen one another and a peak of transmittance at the predetermined wavelength is produced. The predetermined wavelength corresponds to an optical path length difference of the interfering lights and the optical path length difference corresponds to a gap dimension between the pair of reflection films. Accordingly, the optical filter exhibits a transmission wavelength property according to the gap dimension.

In the optical filter disclosed in JP-A-2021-21067, the pair of reflection films are placed in parallel to each other and the gap dimension is uniform. When a light enters the optical filter from a commonly used light source or camera optical system, the angle of the principal ray of the light entering the optical filter is larger as the ray is farther from the optical axis. Accordingly, even when the gap dimension between the pair of reflection films is uniform, the optical path length difference between the interfering lights may vary depending on the incident position to the optical filter. Therefore, there is a problem that the transmission wavelength in the optical filter varies.

### SUMMARY

An optical filter according to an aspect of the present disclosure includes a first reflection film, and a second reflection film placed to face the first reflection film via a gap, wherein, as seen from a direction in which the first reflection film and the second reflection film face, a range in which the first reflection film and the second reflection film overlap forms a light transmission region, and a dimension of the gap in a center portion of the light transmission region is smaller than a dimension of the gap in an outer peripheral portion outside of the center portion within the light transmission region.

### BRIEF DESCRIPTION OF THE DRAWINGS

FIG. 1 is a schematic diagram showing a spectroscopic camera including an optical filter of a first embodiment.

FIG. 2 is a sectional view showing the optical filter of the first embodiment.

FIG. 3 is a plan view showing the optical filter of the first embodiment.

FIG. 4 is a schematic diagram showing a deformed state of reflection films of the first embodiment.

FIG. 5 is a graph showing light transmittance in an optical filter of a comparative example.

FIG. 6 is a graph showing light transmittance in the optical filter of the first embodiment.

FIG. 7 is a sectional view showing an optical filter of a second embodiment.

FIG. 8 is a sectional view showing an optical filter of a third embodiment.

FIG. 9 is a schematic diagram showing a deformed state of reflection films of the third embodiment.

FIG. 10 is a sectional view showing an optical filter of a fourth embodiment.

FIG. 11 is a schematic diagram showing a deformed state of reflection films of the fourth embodiment.

FIG. 12 is a plan view showing an optical filter of a fifth embodiment.

FIG. 13 is a plan view showing an optical filter of a sixth embodiment.

FIG. 14 is a schematic diagram showing a light source device including the optical filter of the first embodiment.

### DESCRIPTION OF EMBODIMENTS

### First Embodiment

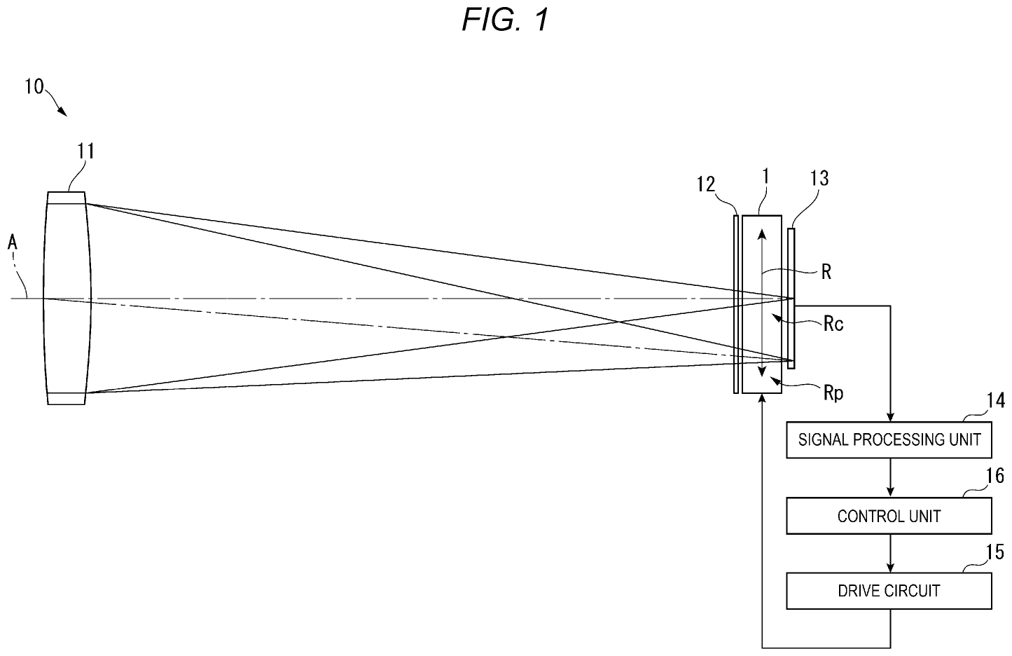

As shown in FIG. 1, an optical filter 1 according to the embodiment can be used for a spectroscopic camera 10 spectroscopically separating a light from an object to be measured into a plurality of wavelengths and imaging.

### Schematic Configuration of Spectroscopic Camera

First, a schematic configuration of the spectroscopic camera 10 is explained. As shown in FIG. 1, the spectroscopic camera 10 includes the optical filter 1, a collecting lens 11, a bandpass filter 12, a light receiving unit 13, a signal processing unit 14, a drive circuit 15, and a control unit 16.

The optical filter 1 is e.g., a wavelength-tunable Fabry-Perot etalon element, the details of which will be described later. The optical filter 1 transmits a light having a desired wavelength of lights entering from the collecting lens 11 through the bandpass filter 12. Further, the optical filter 1 changes the transmission wavelength according to a drive voltage input from the drive circuit 15.

The collecting lens 11 includes one or more lenses. Lights from an object to be measured are collected by the collecting lens 11 and focused on the light receiving unit 13. Further, an optical axis A of the collecting lens 11 is placed to pass through a center portion Rc of a light transmission region R of the optical filter 1.

The bandpass filter 12 is placed between the collecting lens 11 and the optical filter 1. The bandpass filter 12 transmits a light in a specific wavelength range (measurement wavelength range) corresponding to a measurement and cuts lights in wavelength ranges other than the specific wavelength range.

The light receiving unit 13 is an image sensor e.g., a CCD or CMOS, and outputs an image signal according to the received light to the signal processing unit 14.

The signal processing unit 14 includes an amplifier and an A/D converter, and performs signal processing on the image signal input from the light receiving unit 13 and outputs the signal to the control unit 16.

The drive circuit 15 inputs the drive voltage to the optical filter 1 according to a drive command from the control unit 16.

The control unit 16 includes a combination of e.g., a CPU (Central Processing Unit), a memory, etc. and controls the entire operation of the spectroscopic camera 10. The control unit 16 controls the drive circuit 15 based on a target wavelength and measures and analyzes a spectrum to be measured based on the image signal acquired from the signal processing unit 14.

### Configuration of Optical Filter 1

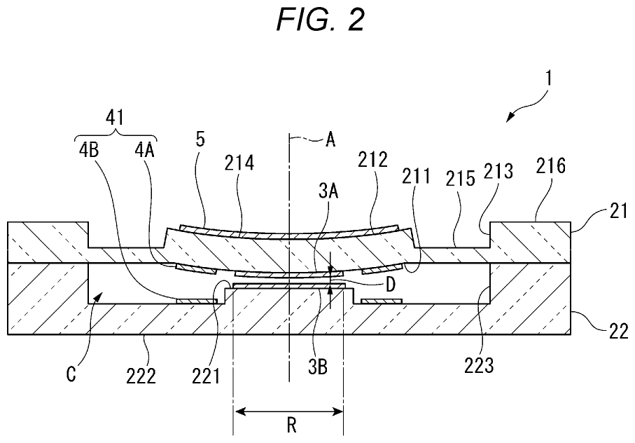

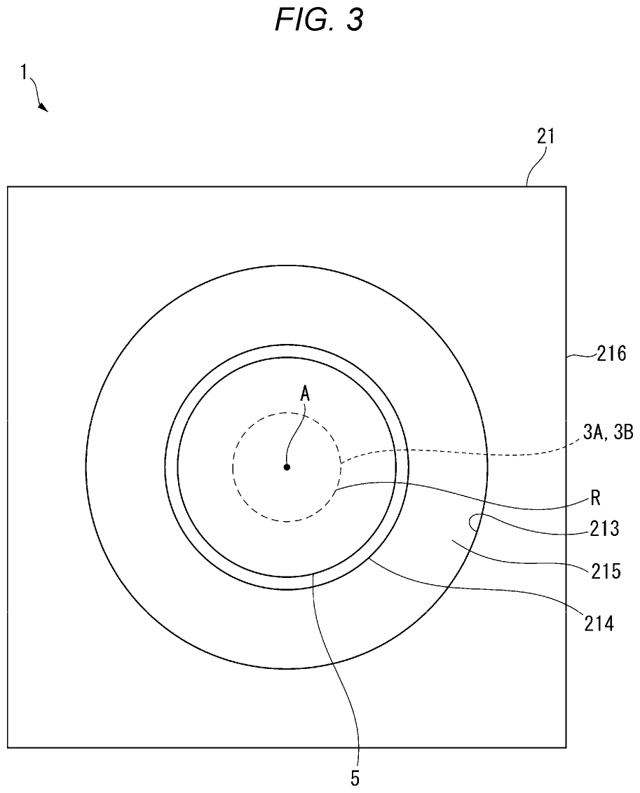

FIG. 2 is a sectional view schematically showing the optical filter 1, and FIG. 3 is a plan view schematically showing the optical filter 1. The optical filter 1 includes a movable substrate 21 and a fixed substrate 22 placed to face each other, a reflection film 3A and an electrode 4A provided on the movable substrate 21, and a reflection film 3B and an electrode 4B provided on the fixed substrate 22.

Note that, in the embodiment, the movable substrate 21 corresponds to a first substrate and the fixed substrate 22 corresponds to a second substrate. Further, the reflection film 3A provided on the movable substrate 21 corresponds to a first reflection film and the reflection film 3B provided on the fixed substrate 22 corresponds to a second reflection film.

The movable substrate 21 and the fixed substrate 22 are placed to face each other in a direction along the optical axis A. Accordingly, the direction in which the movable substrate 21 and the fixed substrate 22 face is parallel to the optical axis A. Further, the movable substrate 21 and the fixed substrate 22 are respectively formed using materials having light transmissivity for the measurement wavelength range e.g., silicon substrates or glass substrates.

The movable substrate 21 has a first surface 211 facing the fixed substrate 22 and a second surface 212 as an opposite surface to the first surface 211. In the second surface 212 of the movable substrate 21, an annular groove 213 is formed. Thereby, the movable substrate 21 includes a movable portion 214 as a part in which the reflection film 3A is provided, a diaphragm portion 215 surrounding the movable portion 214, and a base portion 216 displaceably supporting the movable portion 214 via the diaphragm portion 215. The diaphragm portion 215 is a part in which the thickness of the movable substrate 21 is formed to be thinner than those in the base portion 216 and the movable portion 214 by the groove 213 of the movable substrate 21. Note that the base portion 216 is supported by a housing or the like (not shown).

In the fixed substrate 22, a recessed portion 223 forming a cavity C between the movable substrate 21 and the fixed substrate 22 is formed and, of the fixed substrate 22, a peripheral part around the recessed portion 223 is joined to the base portion 216 of the movable substrate 21. The fixed substrate 22 has a first surface 221 facing the movable substrate 21 and a second surface 222 as an opposite surface to the first surface 221. Note that a base on which the reflection film 3B is provided is formed near the center of the recessed portion 223, and the first surface 221 has a step by the base. Further, though not shown, a part of the fixed substrate 22 projects to the outside of the outer peripheral edge of the movable substrate 21 and forms an electrical component portion.

The reflection film 3A is formed on the first surface 211 of the movable portion 214 and the reflection film 3B is formed on the first surface 221 of the base of the fixed substrate 22. Further, the reflection film 3A and the reflection film 3B face each other via a gap. A dimension of the gap (hereinafter, “gap dimension D”) corresponds to a wavelength of a light transmitted through the optical filter 1.

In a plan view of the optical filter 1, the reflection films 3A, 3B respectively have circular shapes around the optical axis A and are placed to overlap with each other. A region where the reflection films 3A, 3B overlap with each other forms the light transmission region R. A light entering the light transmission region R is multiply reflected between the reflection films 3A, 3B and the lights having a wavelength according to the gap dimension D strengthen one another and are transmitted through the optical filter 1.

As the reflection films 3A, 3B, metal films of Ag or the like or alloy films of Ag alloy or the like may be used. Further, as the reflection films 3A, 3B, dielectric multilayer films formed by alternate stacking of high refractive layers of TiO2 or the like and low refractive layers of SiO2 or the like may be used.

The electrode 4A is formed in an annular shape surrounding the reflection film 3A in the second surface 212 of the movable portion 214, and the electrode 4B is formed in an annular shape surrounding the reflection film 3B outside of the base within the recessed portion 223 of the fixed substrate 22. Further, the electrodes 4A, 4B are placed to face each other and form an electrostatic actuator 41 together. Though not shown, the electrodes 4A, 4B are electrically coupled to the electrical component portion outside of the cavity C via lead wires.

In the optical filter 1 having the above described configuration, one of the electrodes 4A, 4B is grounded and a drive voltage is input to the other, and an electrostatic attractive force acts between the electrodes 4A, 4B. Thereby, the movable portion 214 is displaced toward the fixed substrate 22 side and the gap dimension D is changed.

The optical filter 1 the embodiment further includes a stress film 5 (first stress film) formed on the second surface 212 of the movable portion 214. In the plan view of the optical filter 1, the stress film 5 has a circular shape around the optical axis A and is formed to cover at least the light transmission region R. Further, the center of the stress film 5 is placed to coincide with the center of the light transmission region R (the respective centers of the reflection films 3A, 3B). The stress film 5 of the embodiment spreads in a wider range than the light transmission region R.

Furthermore, the stress film 5 is formed using a material light transmissivity for the measurement wavelength range. A film stress of the stress film 5 is adjusted by appropriate selection of the material, a film thickness, and a film formation condition of the film.

The stress film 5 of the embodiment is a tensile stress film having a tensile stress and applies the tensile stress to the movable portion 214. The stress film 5 is formed using a material e.g., SiO₂, SiON, TiO₂, Al₂O₂, MgF₂, or the like. The stress film 5 may be formed by a single layer or a plurality of layers.

The movable portion 214 is deformed toward the fixed substrate 22 side by the tensile stress of the stress film 5. Thereby, the reflection film 3A is deformed toward the reflection film 3B side along the movable portion 214. On the other hand, the fixed substrate 22 does not have a large deformation and the reflection film 3A is placed along a virtual plane orthogonal to the optical axis A.

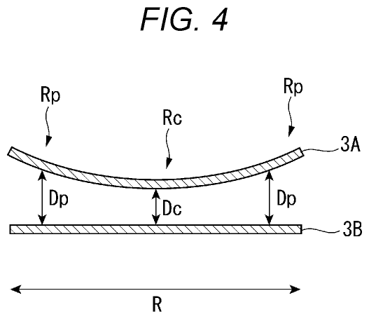

Here, FIG. 4 is a schematic diagram exaggeratingly showing a deformed state of the reflection films 3A, 3B. As shown in FIG. 4, the gap dimension D between the reflection films 3A, 3B is gradually larger radially outward from the center portion Rc of the light transmission region R. For example, a gap dimension Dc of the center portion Rc of the light transmission region R is smaller than a gap dimension Dp of an outer peripheral portion Rp of the light transmission region R.

Note that, during the operation of the optical filter 1, even when the movable portion 214 is displaced by the electrostatic actuator 41, the deformation of the movable portion 214 toward the fixed substrate 22 side by the tensile stress of the stress film 5 is maintained.

Further, the stress applied to the movable portion 214 by the stress film 5 may be a force synergistically added to the stress applied to the movable portion 214 by the reflection film 3A. That is, the reflection film 3A may apply a compressive stress to the movable portion 214 to deform the movable portion 214 toward the fixed substrate 22 side.

### Functions and Effects of First Embodiment

Functions and effects by the optical filter 1 of the embodiment will be explained using a comparative example.

Here, an optical filter according to the comparative example has substantially the same configuration as the optical filter 1 of the embodiment, however, the stress film 5 is not provided and the gap dimension D in the light transmission region R is uniform.

Further, in the respective embodiment and comparative example, as shown in FIG. 1, the principal ray of the light entering the center portion Rc of the light transmission region R is parallel to the optical axis A, however, the principal ray of the light entering the outer peripheral portion Rp of the light transmission region R is inclined relative to the optical axis A (e.g., at an incident angle of 15 degrees). Note that the center portion Rc of the light transmission region R is a part through which the optical axis A passes and the outer peripheral portion Rp of the light transmission region R is an any part at the outer side of the center portion Rc within the light transmission region R.

In the optical filter 1 of the embodiment and the optical filter of the comparative example, a condition for the maximum transmittance is expressed by the following formula (1)

$$2 nD cos θ = m λ . \qquad Formula ( 1 )$$

Note that, in Formula (1), λ is a wavelength of light, n is a refractive index of a medium (vacuum in the embodiment) within the cavity C, D is a gap dimension between the reflection films 3A, 3B, and θ is an incident angle of light to the medium within the cavity C. m is an any integer number and determined according to the measurement wavelength range by the bandpass filter 12. Further, in Formula (1), 2nD cos θ corresponds to an optical path length difference of the light transmitted through the light transmission region R.

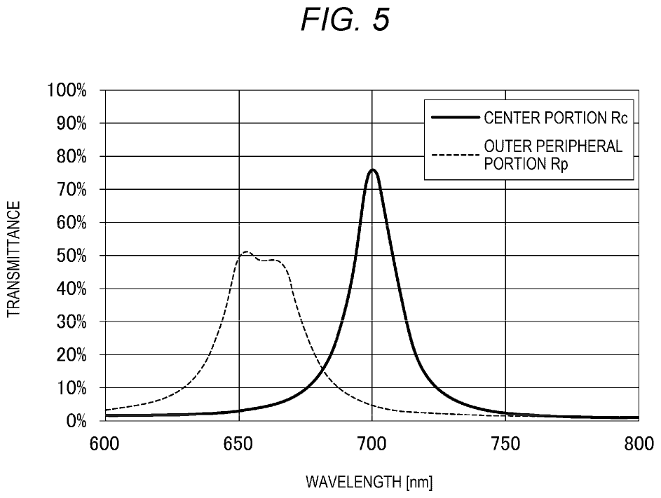

For example, in the comparative example, m=1, n=1, D=350 nm are assumed. With respect to the principal ray of the light entering the center portion Rc of the light transmission region R, for θ=0 degrees, the wavelength λ at which the transmittance is the maximum is 700 nm by the above formula (1). Further, with respect to the principal ray of the light entering the outer peripheral portion Rp of the light transmission region R, for θ=15 degrees, the wavelength λ at which the transmittance is the maximum is 676.1 nm by the above formula (1). As a result, the transmittance in the light transmission region R is shown as a graph in FIG. 5.

FIG. 5 is a graph showing transmittance of lights transmitted through the respective center portion Rc and outer peripheral portion Rp of the light transmission region R in the optical filter of the comparative example. As shown in FIG. 5, in the comparative example, the light entering the center portion Rc of the light transmission region R shows the peak of transmittance near 700 nm and the light entering the outer peripheral portion Rp of the light transmission region R shows the peak of transmittance near 670 nm. That is, in the optical filter of the comparative example, the transmission wavelength in the outer peripheral portion Rp of the light transmission region R is smaller than the transmission wavelength in the center portion Rc of the light transmission region R.

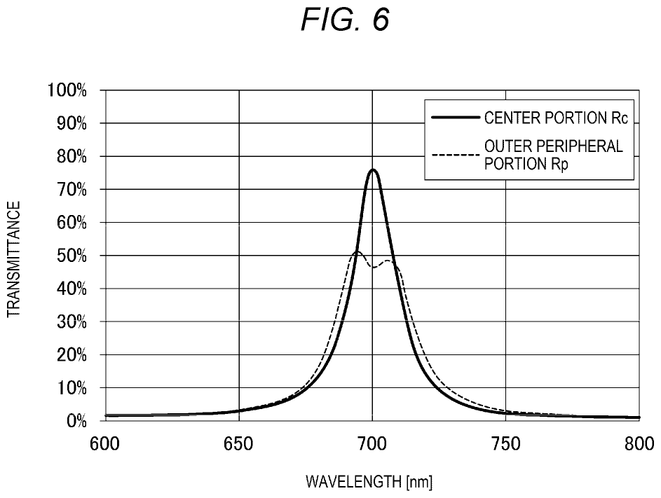

On the other hand, in the embodiment, like the comparative example, m=1, n=1 are assumed. Further, with respect to the light entering the center portion Rc of the light transmission region R, θ=0 degrees and, with respect to the principal ray of the light entering the outer peripheral portion Rp of the light transmission region R, θ=15 degrees. Here, in the embodiment, the stress of the stress film 5 is adjusted, and thereby, the gap dimension D in the outer peripheral portion Rp of the light transmission region R may be made larger than the gap dimension D in the center portion Rc of the light transmission region R. That is, in the center portion Rc and the outer peripheral portion Rp of the light transmission region R, the respective gap dimensions D may be adjusted to equalize the wavelengths λ obtained by the formular (1) to each other. As a result, the transmittance in the light transmission region R is shown as a graph in FIG. 6.

FIG. 6 is a graph showing transmittance of lights transmitted through the respective center portion Rc and outer peripheral portion Rp of the light transmission region R in the optical filter 1 of the embodiment. As shown in FIG. 6, in the optical filter 1 of the embodiment, the stress of the stress film 5 is adjusted and the gap dimensions D in the center portion Rc and the outer peripheral portion Rp of the light transmission region R are adjusted, and thereby, both the respective transmission wavelengths in the center portion Rc and the outer peripheral portion Rp are near 700 nm. That is, in the optical filter 1 of the embodiment, variations of the transmission wavelength in the light transmission region R may be suppressed.

### Second Embodiment

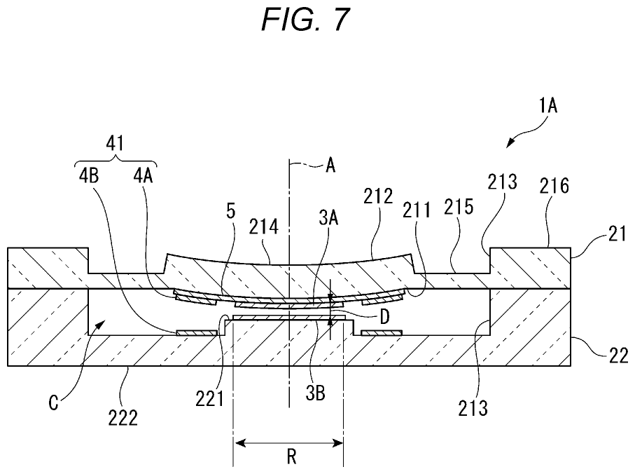

As shown in FIG. 7, an optical filter 1A of the second embodiment has the same configuration as the optical filter 1 of the first embodiment except the placement and the direction of stress of the stress film 5.

Specifically, the stress film 5 of the second embodiment is formed between the first surface 211 of the movable substrate 21 and the reflection film 3A. Further, the stress film 5 of the second embodiment is a compressing stress film having a compressive stress and applies the compressive stress to the movable portion 214 of the movable substrate 21. The stress film 5 as a compressive stress film is formed using a material e.g., ITO, Si, SiO₂, SiON, or TiO₂.

In the second embodiment, the movable portion 214 is deformed toward the fixed substrate 22 side by the tensile stress of the stress film 5, and the reflection film 3A is deformed toward the reflection film 3B side along the movable portion 214. Thereby, like the first embodiment, the gap dimension D is gradually larger radially outward from the center portion Rc of the light transmission region R, and variations of the transmission wavelength in the light transmission region R may be suppressed.

### Third Embodiment

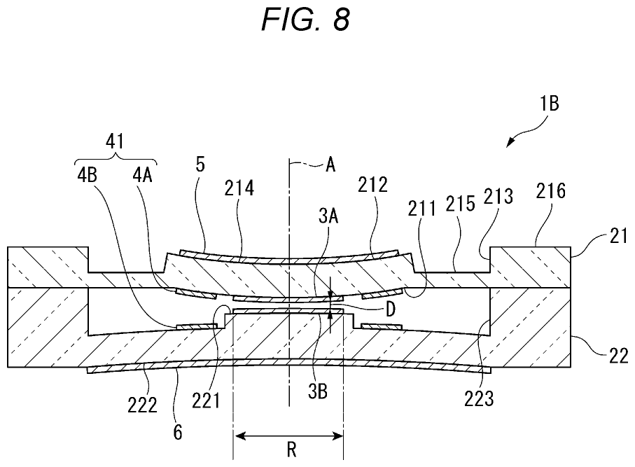

As shown in FIG. 8, an optical filter 1B of the third embodiment has the same configuration as the optical filter 1 of the first embodiment except that not only the stress film 5 (first stress film) is provided on the movable substrate 21 but also a stress film 6 (second stress film) is provided on the fixed substrate 22.

Specifically, the stress film 6 of the third embodiment is a tensile stress film formed on the second surface 222 of the fixed substrate 22 and having a tensile stress. Further, the stress film 6 may be placed to cover the light transmission region R in a plan view of the optical filter 1B like the stress film 5.

In the configuration of the third embodiment, the movable portion 214 is deformed toward the fixed substrate 22 side by the tensile stress of the stress film 5 and the fixed substrate 22 is deformed toward the movable substrate 21 side by the tensile stress of the stress film 6. Thereby, the reflection film 3A is deformed toward the reflection film 3B side along the movable portion 214 and the reflection film 3B is deformed toward the reflection film 3A side along the fixed substrate 22.

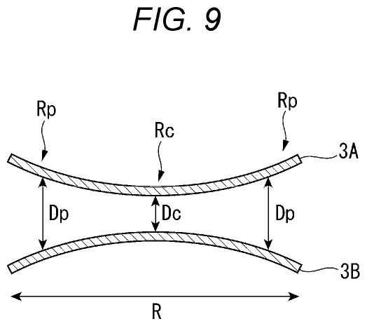

Here, FIG. 9 is a schematic diagram exaggeratingly showing a deformed state of the reflection films 3A, 3B in the third embodiment. The gap dimension D between the reflection films 3A, 3B is gradually larger radially outward from the center portion Rc of the light transmission region R. Accordingly, the gap dimension Dc of the center portion Rc of the light transmission region R is smaller than the gap dimension Dp of the outer peripheral portion Rp of the light transmission region R.

According to the third embodiment, like the first embodiment, variations of the transmission wavelength in the light transmission region R may be suppressed. Further, in the third embodiment, not only the movable portion 214 of the movable substrate 21 but also the fixed substrate 22 is deformed, and a change rate in the radial direction of the gap dimension D of the light transmission region R may be easily largely adjusted.

Note that, in the third embodiment, the stress film 6 may be a compressive stress film formed between the first surface 221 of the fixed substrate 22 and the reflection film 3B, not the tensile stress film formed on the second surface 222 of the fixed substrate 22.

### Fourth Embodiment

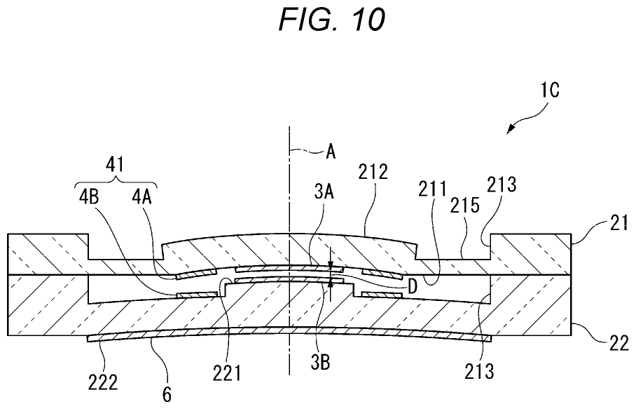

As shown in FIG. 10, an optical filter 1C of the fourth embodiment has substantially the same configuration as the optical filter 1 of the first embodiment except that the stress film 5 is not provided on the movable substrate 21 but a stress film 6 is provided on the fixed substrate 22.

Note that, in the fourth embodiment, unlike the first to third embodiments, the movable substrate 21 corresponds to the second substrate and the fixed substrate 22 corresponds to the first substrate. Further, the reflection film 3A provided on the movable substrate 21 corresponds to the second reflection film and the reflection film 3B provided on the fixed substrate 22 corresponds to the first reflection film.

Specifically, the stress film 6 of the fourth embodiment is formed on the second surface 222 of the fixed substrate 22 like the stress film 6 of the third embodiment. Further, the stress film 6 of the fourth embodiment is a tensile stress film having a tensile stress and applies the tensile stress to the fixed substrate 22. The fixed substrate 22 is deformed toward the movable substrate 21 side by the tensile stress of the stress film 6 and the reflection film 3B is deformed toward the reflection film 3A along the fixed substrate 22.

Note that, in the optical filter 1C of the fourth embodiment, the movable portion 214 is deformed toward the opposite side to the fixed substrate 22 side by a stress of the reflection film 3A or the electrode 4A. Accordingly, the reflection film 3A is deformed toward the opposite side to the reflection film 3B side along the movable portion 214.

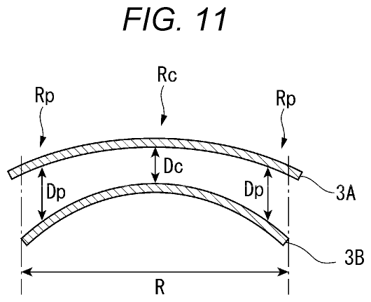

Here, FIG. 11 is a schematic diagram exaggeratingly showing a deformed state of the reflection films 3A, 3B in the fourth embodiment. As shown in FIG. 11, the tensile stress of the stress film 6 is adjusted so that an amount of deformation of the reflection film 3B is larger than an amount of deformation of the reflection film 3A. Thereby, the gap dimension D between the reflection films 3A, 3B is gradually larger radially outward from the center portion Rc of the light transmission region R. Accordingly, the gap dimension Dc of the center portion Rc of the light transmission region R is smaller than the gap dimension Dp of the outer peripheral portion Rp of the light transmission region R.

According to the fourth embodiment, like the first embodiment, variations of the transmission wavelength in the light transmission region R may be suppressed. Further, the configuration of the fourth embodiment is effective when it is difficult to provide a stress film (the stress film 5 in the embodiment) on one substrate (the movable substrate 21 of the embodiment).

### Fifth Embodiment

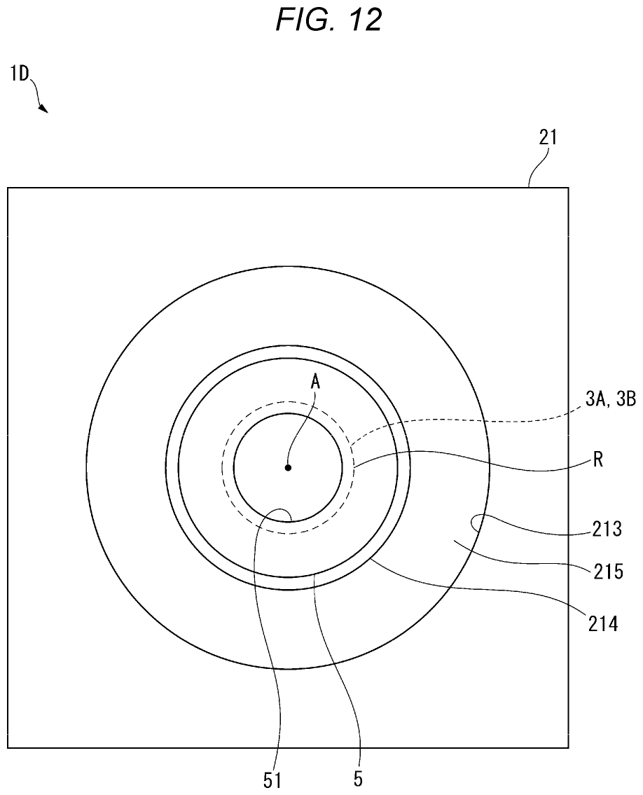

As shown in FIG. 12, an optical filter 1D of the fifth embodiment has the same configuration as the optical filter 1 of the first embodiment except the shape of the stress film 5.

Specifically, the stress film 5 of the fifth embodiment has a ring shape having a circular hole 51 formed at the center in a plan view of the optical filter 1D. Further, an inner circumference and an outer circumference of the stress film 5 have circular shapes around the center portion Rc of the light transmission region R (through which the optical axis A passes in FIG. 12).

In the fifth embodiment, while the gap dimension D between the reflection films 3A, 3B may be made uniform in a region near the center portion of the light transmission region R (i.e., a region corresponding to the hole 51 of the stress film 5), the gap dimension D may be made gradually larger radially outward outside of the region. According to the fifth embodiment, variations of the transmission wavelength in the light transmission region R may be suppressed.

### Sixth Embodiment

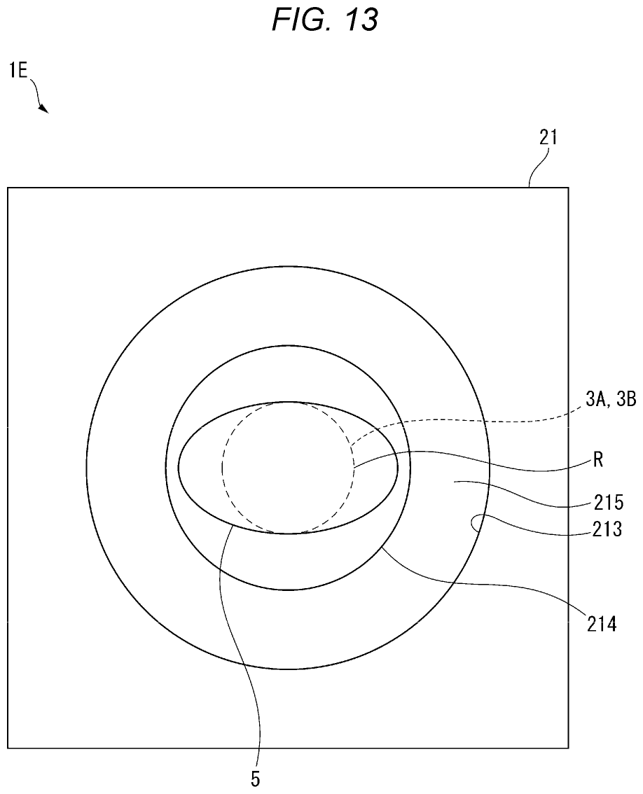

As shown in FIG. 13, an optical filter 1E of the sixth embodiment has the same configuration as the optical filter 1 of the first embodiment except the shape of the stress film 5.

Specifically, the stress film 5 of the sixth embodiment has an oval shape in one direction orthogonal to the optical axis A as a longitudinal direction.

In the sixth embodiment, the shape of the stress film 5 is adjusted according to the stress applied to the movable portion 214 from the reflection film 3A or the electrode 4A. For example, on a virtual plane orthogonal to the optical axis A, directions of the stresses applied by the reflection film 3A and the electrode 4A and the longitudinal direction of the stress film 5 are placed to be orthogonal to each other, and the movable portion 214 may be preferably deformed toward the fixed substrate 22 side. Thereby, the gap dimension D between the reflection films 3A, 3B may be made gradually larger radially outward from the center portion Rc of the light transmission region R, and variations of the transmission wavelength in the light transmission region R may be suppressed.

### MODIFIED EXAMPLES

The present disclosure is not limited to the above described respective embodiments, but the present disclosure includes configurations obtained by modifications, improvements, appropriate combinations of the respective embodiments, etc. within the scope in which the purpose of the present disclosure may be achieved.

### Modified Example 1

The correspondence relationship between the movable substrate 21 and the fixed substrate 22 of the above described respective embodiments and the first substrate and the second substrate of the present disclosure can be rearranged.

For example, in the first and second embodiments, the stress film 5 is provided on the first surface 211 or the second surface 212 of the movable substrate 21 and the stress film 6 is not provided on the fixed substrate 22. As a modification thereof, the stress film 5 may not be provided on the movable substrate 21 and the stress film 6 may be provided on the first surface 221 or the second surface 222 of the fixed substrate 22.

Further, in the fourth embodiment, the movable substrate 21 is deformed toward the fixed substrate 22 side and the fixed substrate 22 is deformed toward the opposite side to the movable substrate 21 side, and the amount of deformation of the movable substrate 21 is larger than the amount of deformation of the fixed substrate 22. As a modification thereof, the movable substrate 21 may be deformed toward the opposite side to the fixed substrate 22 side, the fixed substrate 22 may be deformed toward the movable substrate 21 side, and the amount of deformation of the fixed substrate 22 may be larger than the amount of deformation of the movable substrate 21.

### Modified Example 2

In the above described respective embodiments, a plurality of stress films 5, 6 may be provided on each of the movable substrate 21 and the fixed substrate 22.

For example, in the first to third embodiments, the stress film 5 having the tensile stress may be provided on the first surface 211 of the movable substrate 21 and the stress film 5 having the compressive stress may be provided on the second surface 212 of the movable substrate 21.

Further, in the third and fourth embodiments, the stress film 6 having the tensile stress may be provided on the first surface 221 of the fixed substrate 22 and the stress film 6 having the compressive stress may be provided on the second surface 222 of the fixed substrate 22.

### Modified Example 3

In the above described respective embodiments, the stress film 5 has the circular shape, the circular ring shape, or the oval shape, however, the present disclosure is not limited to that. For example, the stress film 5 may have another shape such as a rectangular shape or a rectangular ring shape. Further, the same description as the description of the shape of the stress film 5 may be applied to the shape of the stress film 6.

### Modified Example 4

In the above described respective embodiments, the center portions of the stress films 5, 6 are not limited to coincide with the center portion Rc of the light transmission region R as seen from a direction in which the movable substrate 21 and the fixed substrate 22 face, but may be placed off the center portion Rc.

Further, in the above described respective embodiments, the stress films 5, 6 are placed to cover the light transmission region R as seen from the direction in which the movable substrate 21 and the fixed substrate 22 face, but not limited to that. For example, the stress films 5, 6 may at least partially overlap with the light transmission region R or not overlap with the light transmission region R. When the stress film 5 (or the stress film 6) does not overlap with the light transmission region R, it is only necessary that the gap dimension Dc of the center portion Rc of the light transmission region R is smaller than the gap dimension Dp of the outer peripheral portion Rp within the light transmission region R by the stress of the stress film 5 (or the stress film 6) deforming the movable portion 214 (or the fixed substrate 22).

### Modified Example 5

In the above described respective embodiments, the gap dimension Dc of the light transmission region R is adjusted by the stress of the stress film 5 (or the stress film 6) deforming the movable portion 214 (or the fixed substrate 22), but not limited to that. For example, the gap dimension Dc of the light transmission region R may be adjusted by adjustment of the stress of any of the reflection films 3A, 3B and the electrodes 4A, 4B mounted on the movable portion 214 or the fixed substrate 22. That is, the optical filter according to the modified example may not include the stress films 5, 6 and the gap dimension Dc of the center portion Rc of the light transmission region R may be smaller than the gap dimension Dp of the outer peripheral portion Rp of the light transmission region R by the adjustment of the stress of any of the reflection films 3A, 3B and the electrodes 4A, 4B.

### Modified Example 6

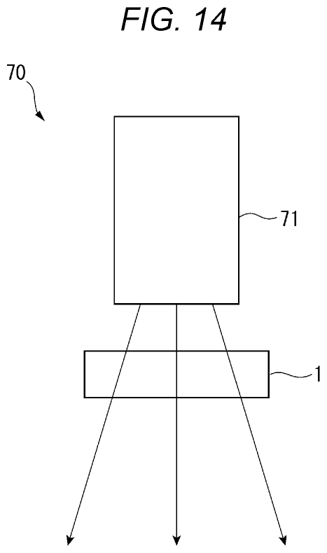

In the above described respective embodiments, the spectroscopic camera 10 including the optical filter 1 is exemplified, however, the present disclosure is not limited to that. For example, as shown in FIG. 14, the optical filter 1 may be used for a light source device 70. The light source device 70 includes a light source 71 such as an optical fiber and the optical filter 1 transmitting a light having a desired wavelength of lights spread and output from the light source 71. The light source device 70 radiates the light having the desired wavelength transmitted through the optical filter 1 toward an object.

### Summary of Present Disclosure

(1) An optical filter according to an aspect of the present disclosure includes a first reflection film, and a second reflection film placed to face the first reflection film via a gap, in which, as seen from a direction in which the first reflection film and the second reflection film face, a range in which the first reflection film and the second reflection film overlap forms a light transmission region, and a dimension of the gap in a center portion of the light transmission region is smaller than a dimension of the gap in an outer peripheral portion outside of the center portion within the light transmission region.

In the configuration, even in a case where angles of principal rays of an incident light are different between the center portion and the outer peripheral portion of the light transmission region when a light enters the optical filter from a commonly used light source or camera optical system, transmission wavelengths in the respective center portion and outer peripheral portion of the light transmission region may be made equal. Thereby, variations of the transmission wavelength in the light transmission region may be suppressed.
(2) The optical filter according to the aspect of the present disclosure further includes a first substrate on which the first reflection film is provided, a second substrate placed to face the first substrate, on which the second reflection film is provided, and a first stress film provided on the first substrate, in which the first stress film may apply a stress to the first substrate to deform the first reflection film toward the second reflection film side.

In the configuration, the respective gap dimensions of the center portion and the outer peripheral portion of the light transmission region may be preferably adjusted by adjustment of the stress of the stress film.
(3) In the aspect of the present disclosure, the first substrate may include a first surface facing the second substrate and a second surface at an opposite side to the first surface, and the first stress film may be a compressive stress film provided between the first surface of the first substrate and the first reflection film or a tensile stress film provided on the second surface of the first substrate.
(4) The optical filter according to the aspect of the present disclosure further includes a second stress film provided on the second substrate, in which the second stress film may apply a stress to the second substrate to deform the second reflection film toward the first reflection film side.

In the configuration, not only the movable portion of the first substrate but also the second substrate are deformed, and the change rate in the radial direction of the gap dimension of the light transmission region may be easily largely adjusted.
(5) In the aspect of the present disclosure, the second substrate may include a first surface facing the first substrate and a second surface at an opposite side to the first surface, and the second stress film may be a compressive stress film provided between the first surface of the second substrate and the second reflection film or a tensile stress film provided on the second surface of the second substrate.
(6) In the aspect of the present disclosure, the second reflection film may be deformed to an opposite side to the first substrate side, and an amount of deformation of the first reflection film may be larger than an amount of deformation of the second reflection film.

The configuration is effective when it is difficult to provide the stress film on the second substrate.
(7) In the aspect of the present disclosure, at least a part of the first stress film may be placed to overlap with the light transmission region as seen from the direction in which the first reflection film and the second reflection film face.

According to the configuration, the respective gap dimensions of the center portion and the outer peripheral portion of the light transmission region may be preferably adjusted.
(8) In the aspect of the present disclosure, a center portion of the first stress film may coincide with the center portion of the light transmission region as seen from the direction in which the first reflection film and the second reflection film face.

According to the configuration, the gap dimension may be adjusted with balance from the center portion to the outer peripheral portion of the light transmission region.
(9) In the aspect of the present disclosure, the first stress film may have a ring shape.
(10) In the aspect of the present disclosure, an inner circumference and an outer circumference of the first stress film may have circular shapes around the center portion of the light transmission region.

What is claimed is:

1. An optical filter comprising:
a first reflection film; and
a second reflection film placed to face the first reflection film via a gap, wherein
as seen from a direction in which the first reflection film and the second reflection film face, a range in which the first reflection film and the second reflection film overlap forms a light transmission region, and
a dimension of the gap in a center portion of the light transmission region is smaller than a dimension of the gap in an outer peripheral portion outside of the center portion within the light transmission region.

2. The optical filter according to claim 1, further comprising:
a first substrate on which the first reflection film is provided;
a second substrate placed to face the first substrate, on which the second reflection film is provided; and
a first stress film provided on the first substrate, wherein
the first stress film applies a stress to the first substrate to deform the first reflection film toward the second reflection film side.

3. The optical filter according to claim 2, wherein
the first substrate includes a first surface facing the second substrate and a second surface at an opposite side to the first surface, and
the first stress film is a compressive stress film provided between the first surface of the first substrate and the first reflection film or a tensile stress film provided on the second surface of the first substrate.

4. The optical filter according to claim 2, further comprising a second stress film provided on the second substrate, wherein
the second stress film applies a stress to the second substrate to deform the second reflection film toward the first reflection film side.

5. The optical filter according to claim 4, wherein
the second substrate includes a first surface facing the first substrate and a second surface at an opposite side to the first surface, and
the second stress film is a compressive stress film provided between the first surface of the second substrate and the second reflection film or a tensile stress film provided on the second surface of the second substrate.

6. The optical filter according to claim 1, wherein
the second reflection film is deformed to an opposite side to the first substrate side, and
an amount of deformation of the first reflection film is larger than an amount of deformation of the second reflection film.

7. The optical filter according to claim 2, wherein
at least a part of the first stress film is placed to overlap with the light transmission region as seen from the direction in which the first reflection film and the second reflection film face.

8. The optical filter according to claim 7, wherein
a center portion of the first stress film coincides with the center portion of the light transmission region as seen from the direction in which the first reflection film and the second reflection film face.

9. The optical filter according to claim 8, wherein
the first stress film has a ring shape.

10. The optical filter according to claim 9, wherein
an inner circumference and an outer circumference of the first stress film have circular shapes around the center portion of the light transmission region.
